(19) United States
(12) Patent Application Publication
(10) Pub. No.: US 2007/0103275 A1
(43) Pub. Date: May 10, 2007

(54) Medical material distributing and consulting system using IC tag

(75) Inventors: Nobutoshi Nakano, Tokyo (JP); Hitoshi Hara, Tokyo (JP); Koji Asano, Tokyo (JP)

Correspondence Address: NIXON & VANDERHYE, PC, 901 NORTH GLEBE ROAD, 11TH FLOOR, ARLINGTON, VA, 22203, US

(73) Assignee: Bit corn laboratory Inc., Tokyo (JP)

(21) Appl. No.: 11/345,276

(22) Filed: Feb. 2, 2006

(30) Foreign Application Priority Data
Nov. 10, 2005 (JP) 2005-325745

(51) Int. Cl. G08B 5/22

(52) U.S. Cl. 340/286.07

(57) ABSTRACT

In order to provide a medical material distributing and consulting system using an IC tag that is capable of obtaining further detailed information in comparison to the information memorized in the IC tag or a hospital clinic identification card, with respect to the medical material such as a medicine, the medical material distributing and consulting system 1 comprises a server 7 and a mobile terminal device 6 communicable with the server through a communication line network 8 using Internet. The mobile terminal device has an IC tag reader-writer 5 for carrying out reading operation and/or writing operation with respect to an IC tag 4 installed in the medical material 2 or the IC hospital clinic identification card 3. The mobile terminal device comprises at least a IC tag data receiving section for receiving IC tag data from the IC tag reader-writer which reads the IC tag data out of the IC tag, and a server data request transmitting section for a data request signal to the server in order to request server data relative to the IC tag data.

### BACKGROUND OF THE INVENTION

1. Field of the Invention

The present invention relates to a medical material distributing and consulting system which uses an IC tag. In the medical material distributing system and consulting system, a server is communicable with a mobile terminal device or a computer having an IC tag reader and writer for carrying out reading and/or writing with respect to the IC tag which is installed in a medical material or an IC hospital clinic identification card, through a communication line network using Internet.

2. Description of the Prior Art

Such a medical material distributing and consulting system is disclosed in Japanese Unexamined Patent Publication No. 2003-95440 as a conventional system. More particularly, Japanese Unexamined Patent Publication No. 2003-95440 discloses a medicine information managing system for managing information with respect to medicines by using a server for managing the information with respect to the medicines, a non-contact IC tag installed on a medicine case, and a plurality of communication terminal devices connected to the server through communication lines. In the medicine managing system, the non-contact IC tag has memorizing means for memorizing medicine identifying data for use in making identification between medicines which are kept in the medicine cases, respectively. Each of communication terminal devices has an antenna and reception-transmission means. The antenna is for reading the medicine identifying data which are memorized in the memorizing means of non-contact IC tag. The reception-transmission means is for transmitting the medicine identifying data to the server and is for receiving information from the server. The server has a medicine information database for registering stock information of medicines in accordance with the medicine identifying data which are received from each of the communication terminal devices.

In Japanese Unexamined Patent Publication No. 2003-95440, a communication terminal device positioned in a hospital has reading means, an antenna, and check-judgment means. The reading means is for reading prescription data memorized in memorizing means of a chart card. The antenna is for taking or reading the medicine identifying data for distinguishing the medicine that is memorized in the memorizing means of the non-contact IC tag. The check-judgment means is for checking the prescription data read by the reading means against the medicine identifying data for distinguishing the medicine that is taken by the antenna. Furthermore, the check-judgment means is for judging whether or not the medicine is applicable to the medicine which is described in the prescription.

The medicine information managing system described in Japanese Unexamined Patent Publication No. 2003-95440 is for supplying a pharmaceutical company or a medicine distributing company with information with respect to the medicines used by a medical institution, through a communication line. As a result, it is possible to correctly carry out an administration with respect to the medicine described in the prescription.

However, the medicine information managing system described in Japanese Unexamined Patent Publication No. 2003-95440 is for registering the stock information in the server with respect to the medicines. Furthermore, medicine information managing system described in Japanese Unexamined Patent Publication No. 2003-95440 is for judging whether or not the medicine is applicable to the medicine which is described in the prescription. In other words, the medicine information managing system described in Japanese Unexamined Patent Publication No. 2003-95440 uses the defined information which is memorized in the non-contact IC tag and the chart card.

Accordingly, it is impossible to obtain further detailed information in comparison to the information which is memorized in the IC tag or a hospital clinic identification card such as the chart card, with respect to medical materials such as the medicines, in the medicine information managing system described in Japanese Unexamined Patent Publication No. 2003-95440.

### SUMMARY OF THE INVENTION

Taking the above-mentioned circumstances into consideration, it is an object of the present invention to provide a medical material distributing and consulting system using an IC tag that is capable of obtaining further detailed information in comparison to information which is memorized in the IC tag or a hospital clinic identification card, with respect to the medical material such as a medicine.

According to a first aspect of the present invention, there is provided a medical material distributing and consulting system comprising a server and a mobile terminal device communicable with said server through a communication line network using Internet. The mobile terminal device has an IC tag reader-writer for carrying out reading operation and/or writing operation with respect to an IC tag which is installed in a medical material or an IC hospital clinic identification card. The mobile terminal device comprises IC tag reading request means for transmitting a reading request signal for the IC tag to the IC tag reader-writer, IC tag data receiving means for receiving IC tag data from the IC tag reader-writer which reads the IC tag data out of the IC tag, server data request transmitting means for a data request signal to the server in order to request server data relative to the IC tag data, server data receiving means for receiving data from the server, and server data displaying means for displaying the data received from the server. The server comprises data request receiving means for receiving the data request signal from the mobile terminal device, extracting means for extracting data from a database installed in the server, in accordance with the data request signal, and extracted data transmitting means for transmitting the extracted data to the mobile terminal device.

According to the first aspect of the present invention, it is possible to provide the medical material distributing and consulting system that uses the IC tag and that is capable of obtaining further detailed information by the mobile terminal device in comparison to the information which is memorized in the IC tag or the information memorized in hospital clinic identification card, with respect to the medical material such as medicine.

According to a second aspect of the present invention, the medical material distributing and consulting system comprises a computer communicable with the server through the communication line network using Internet. The computer has an IC tag reader-writer for carrying out reading operation and/or writing operation with respect to the IC tag which is installed in the medical material or said IC hospital clinic identification card. The computer comprises IC tag reading request means for transmitting a reading request signal for the IC tag to the IC tag reader-writer, IC tag data receiving means for receiving IC tag data from the IC tag reader-writer which reads the IC tag data from said IC tag, server data request transmitting means for a data request signal to the server in order to request server data relative to the IC tag data, server data receiving means for receiving data from the server, and server data displaying means for displaying the data received from the server.

According to the second aspect of the present invention, it is possible to provide the medical material distributing and consulting system that uses the IC tag and that is capable of obtaining further detailed information by the computer in comparison to the information memorized in the IC tag or the information memorized in hospital clinic identification card with respect to the medical material such as medicine, in addition to the effect according to the first aspect of the present invention.

According to a third aspect of the present invention, the data request signal transmitted by the server data request transmitting means is representative of a URL.

According to the third aspect of the present invention, it is possible to easily obtain necessary data when requesting the Web page including the request data in accordance with the URL, in addition to the effect according to the first or the second aspect of the present invention, inasmuch as the data request signal transmitted by the server data request transmitting means is representative of the URL.

According to a fourth aspect of the present invention, the data request signal transmitted by the server data request transmitting means is representative of a medical material identifying number for use in identifying the medical material, or an IC hospital clinic identification card identifying number for use in identifying an IC hospital clinic identification card, and an insurance number for patient having the IC hospital clinic identification card.

According to the fourth aspect of the present invention, it is possible to certainly obtain the necessary data when requesting the server data in accordance with the medical material identifying number or the IC hospital clinic identification card identifying number and the insurance number of patient, in addition to the effect according to any one of the first to the third aspects of the present invention, inasmuch as the data request signal transmitted by the server data request transmitting means is representative of the medical material identifying number for use in identifying the medical material or the IC hospital clinic identification card identifying number for use in identifying the IC hospital clinic identification card and the insurance number of patient who holds the IC hospital clinic identification card.

According to a fifth aspect of the present invention, the server comprises Web page providing means for providing the data of the database as a Web page. The extracted data transmitting means transmits the Web page provided by the Web page providing means, to the mobile terminal device as the extracted data.

According to the fifth aspect of the present invention, it is possible to provide the data in a simple system using the Internet and to display the data in an easily visible state by the Web page in addition to the effect according to any one of the first to the fourth aspects of the present invention, inasmuch as the server comprises the Web page providing means for providing the data of database in form of the Web page and the extracted data transmitting means supplies the mobile terminal device with the Web page provided by the Web page providing means.

According to a sixth aspect of the present invention, the mobile terminal device or the computer comprises IC tag data displaying means for displaying the IC tag data received from the IC tag.

According to the sixth aspect of the present invention, it is possible to see the IC tag data on the mobile terminal device or the computer in addition to the effect according to any one of the first to the fifth aspects of the present invention, inasmuch as the mobile terminal device or the computer comprises the IC tag data displaying means for displaying the received IC tag data.

According to a seventh aspect of the present invention, the IC tag reader-writer installed in the mobile terminal device is added to the mobile terminal device internally or externally.

According to the seventh aspect of the present invention, it is possible to simplify the outside appearance in the combined structure of the IC tag reader-writer and the mobile terminal device in addition to the effect according to any one of the first to the sixth aspects of the present invention, in case where the IC tag reader-writer is added to the mobile terminal device internally, inasmuch as the IC tag reader-writer 5 is added to the mobile terminal device internally or externally. In case where the IC tag reader-writer is added to the mobile terminal device externally, it is possible to detach the IC tag reader-writer from the mobile terminal device when the IC tag reader-writer is not used.

### BRIEF DESCRIPTION OF THE DRAWINGS

FIG. 1 shows an outline view for describing a medical material distributing and consulting system according to the present invention;

FIG. 2A shows a view for describing main functions of a mobile terminal device in the present invention;

FIG. 2B shows a view for describing main functions of a computer in the present invention;

FIG. 2C shows a view for describing main functions of a server in the present invention;

FIG. 3 shows an outline view for describing a flow of a medical material distributing system in the medical material distributing and consulting system according to the present invention; and

FIG. 4 shows an outline view for describing a flow of a consulting system in the medical material distributing and consulting system according to the present invention.

### DESCRIPTION OF THE PREFERRED EMBODIMENT

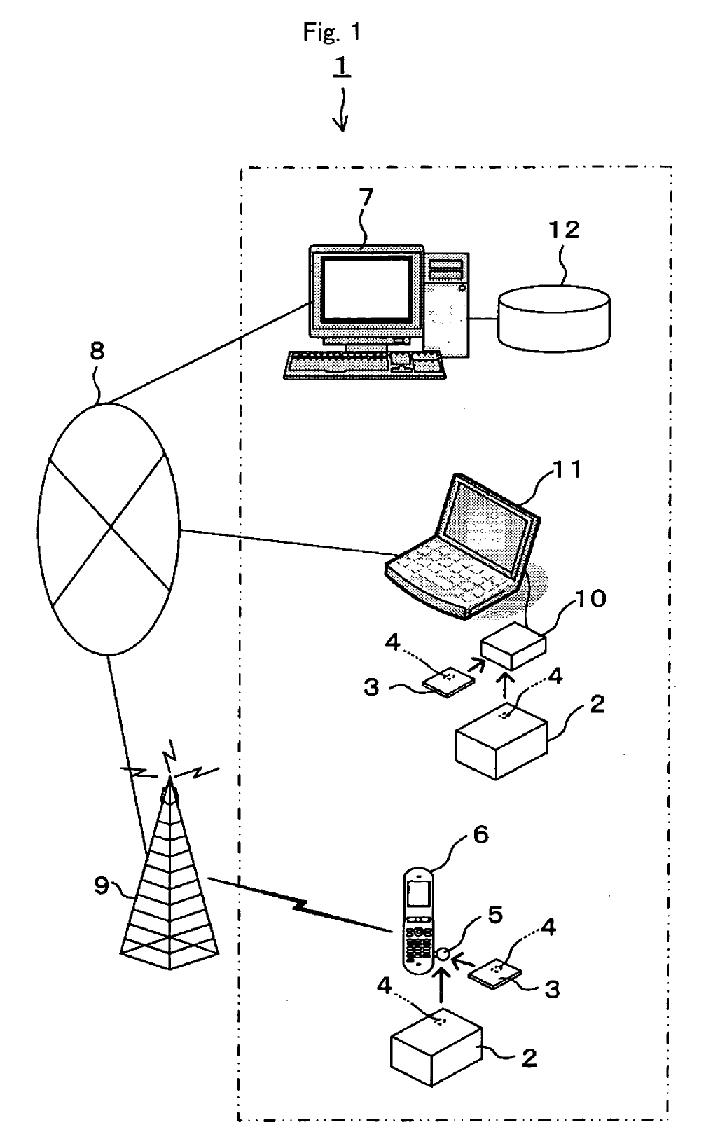

Description will be made as regards a preferred embodiment according to the present invention, with reference to drawings. In FIG. 1, a medical material distributing system and consulting system 1 according to the present invention uses an IC tag and is mainly constructed in a hospital or a clinic. The medical material distributing system and consulting system 1 comprises at least one mobile terminal device 6 and a server 7. The mobile terminal device 6 has an IC tag reader-writer 5 for carrying out reading and/or writing with respect to an IC tag 4 which is installed in a medical material 2 or an IC hospital clinic identification card 3. The mobile terminal device 6 is communicable to the server through a communication line network 8 using Internet. Incidentally, the mobile terminal device 6 is connected to the communication line network 8 through a base station 9. In addition, the mobile terminal device 6 may be, for example, a PHS (Personal Handy phone System) which generates a slight current which is usable in the hospital.

The medical material includes a dental material. The IC tag 4, which is installed in the medical material 2, memorizes tag identifying information, medical material identifying information, and supplier information. The IC hospital clinic identification card 3 memorizes consulting information and chart information. The IC tag, which is installed in the IC hospital clinic identification card 3, memorizes tag identifying information, identifying information for the IC hospital clinic identification card 3, and an insurance number of the IC hospital clinic identification card holder.

Furthermore, at least one computer 11 such as a personal computer is communicable to the server 7 through the communication line network 8 using Internet. The computer 11 has an IC tag reader-writer 10 for carrying out reading and/or writing with respect to the IC tag 4 which is installed in the medical material 2 or the IC hospital clinic identification card 3.

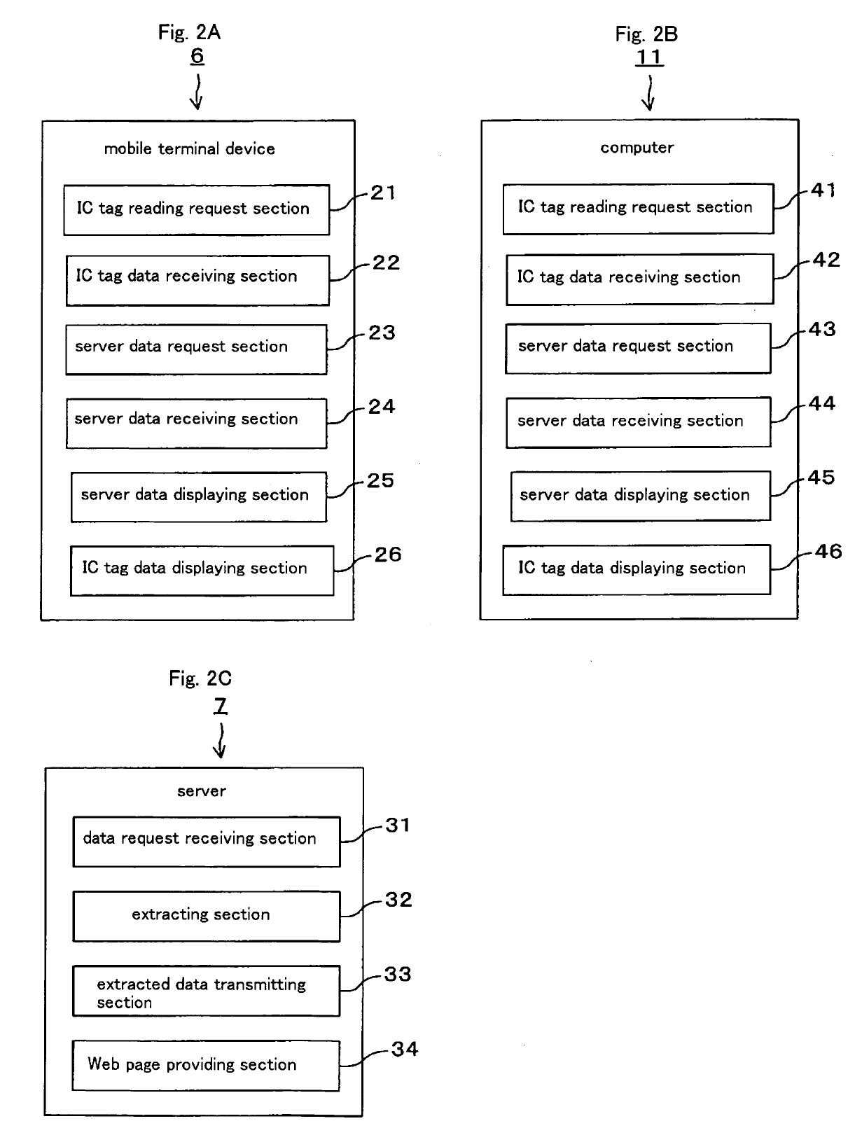

As shown in FIG. 1 and FIGS. 2A to 2C, the mobile terminal device 6 comprises an IC tag reading request section 21, an IC tag data receiving section 22, a server data request transmitting section 23, a server data receiving section 24, an a server data displaying section 25. The IC tag reading request section 21 is for transmitting a reading request signal for the IC tag 4 to the IC tag reader-writer 5. The IC tag data receiving section 22 is for receiving an IC tag data from the IC tag reader-writer 5 which reads the IC tag data out of the IC tag 4. The server data request transmitting section 23 is for transmitting a data request signal to the server 7, in order to request a server data concerned to the IC tag data, to the server 7. The server data receiving section 24 is for receiving the server data from the server 7. The server data displaying section 25 is for displaying the received server data. The server 7 comprises a data request receiving section 31, an extracting section 32, and an extracted data transmitting section 33. The data request receiving section 31 is for receiving the data request signal from the mobile terminal device 6. The extracting section 32 is for extracting data as the extracted data from a database 12 which is installed in the server 7, in accordance with the data request signal. The extracted data transmitting section 33 is for transmitting the extracted data to the mobile terminal device 6.

In addition, the computer 21 comprises an IC tag reading request section 41, an IC tag data receiving section 42, a server data request transmitting section 43, a server data receiving section 44, an a server data displaying section 45 all of which have functions similar to the IC tag reading request section 21, the IC tag data receiving section 22, the server data request transmitting section 23, the server data receiving section 24, the server data displaying section 25 of the mobile terminal device 6, respectively.

The server data request transmitting section 23 may transmit an URL as the data request signal to the server 7. The server data request transmitting section 23 may transmit a medical material identifying number for identifying the medical material, as the data request signal to the server 7. Alternatively, the server data request transmitting section 23 may transmit an IC hospital clinic identification card number for identifying the hospital clinic identification card 3 and an insurance number of a patient who holds the IC hospital clinic identification card 3, as the data request signal to the server 7.

The server 7 further comprises a Web page providing section 34 for providing the data of database 12 to the mobile terminal device 6 by a Web page. The extracted data transmitting section 33 transmits the Web page provided by the Web page providing section 34, to the mobile terminal device 6.

The mobile terminal device 6 further comprises an IC tag data displaying section 26 for displaying the received IC tag data. Similarly, the computer 11 comprises an IC tag data displaying section 46 which has a function similar to the IC tag data displaying section 26.

The IC tag reader-writer 5 is added to the mobile terminal device 6 either internally or externally (the drawing shows an example in which IC tag reader-writer 5 is added to the mobile terminal device 6 externally). In case where the IC tag reader-writer 5 is added to the mobile terminal device 6 externally, a socket portion (not shown), which is for inserting terminals of the IC tag reader-writer 5 into the mobile terminal device 6, is formed on an outer region of the mobile terminal device 6. In case where the IC tag reader-writer 5 is added to the mobile terminal device 6 internally, it is possible to simplify an outside appearance of combined structure which is formed by the IC tag reader-writer 5 and the mobile terminal device 6. On the other hand, it is possible to detach the IC tag reader-writer 5 from the mobile terminal device 6 when the IC tag reader-writer 5 is not used, in case where the IC tag reader-writer 5 is added to the mobile terminal device 6 externally.

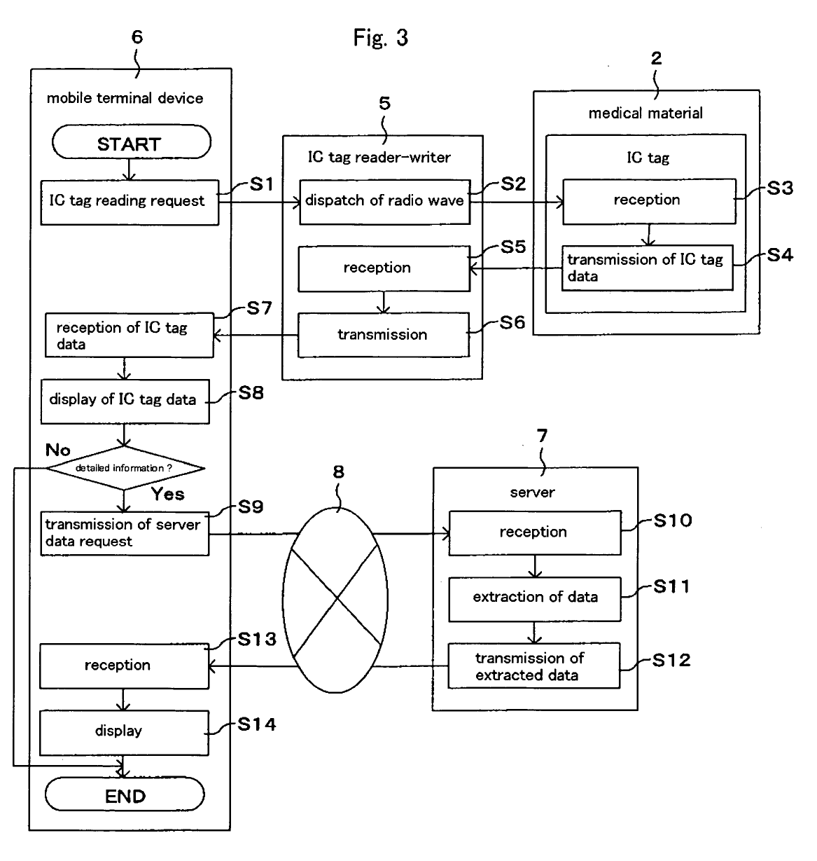

Referring to FIG. 3 together with FIG. 1 and FIGS. 2A to 2C, description will proceed to a processing flow of the medical material distributing system in the medical material distributing system and consulting system 1, on using the mobile terminal device 6.

At a first step S1, an operator operates the mobile terminal device 6, in order to transmit the reading request signal for the IC tag 4 to the IC tag reader-writer 5 by the IC tag reading request section 21. Preferably, the operator may be one of the parties that is concerned to the hospital or the clinic and that holds the mobile terminal device 6.

At a second step S2, the IC tag reader-writer 5 is responsive to the reading request signal and dispatches a radio wave to the IC tag 4 which is installed in the medical material 2. When the IC tag 4 receives the radio wave from the IC tag reader-writer 5 at a third step S3, the IC tag 4 dispatches the IC tag data to the IC tag reader-writer 5 at a fourth step S4. The IC tag data is representative of the URL of Web page information which includes the identifying number of IC tag 4 and the information of medical material 2. When the IC tag reader-writer 5 receives the IC tag data from the IC tag 4 at the fifth step S5, the IC tag reader-writer 5 transmits the IC tag data to the mobile terminal device 6 at a sixth step S6.

When the mobile terminal device 6 receives the IC tag data from the IC tag reader-writer 5 by the IC tag data receiving section 22 at a seventh step S7, the mobile terminal device 6 displays the received IC tag data by the IC tag data displaying section 26 at an eighth step S8.

In case where the user of mobile terminal device 6 does not need further detailed information, the process proceeds to end. In case where the user of mobile terminal device 6 needs the further detailed information, the mobile terminal device 6 transmits the data request signal to the server 7 by the server data request transmitting section 23 through the communication line network 8 at a ninth step S9, in order to request the server data relative to the IC tag data.

When the server 7 receives the data request signal by the data request receiving section 31 at a tenth step S10, the server 7 extracts the server data from the database 12 which is installed in the server 7, by the extracting section 32 in accordance with the data request signal at an eleventh step S11.

At that time, the extracting section 32 extracts the Web page information from the database 12. The Web page information is produced by the Web page providing section 34 in advance and is relative to the URL. The server data relative to the URL are set in the Web page information.

In case where the data request signal is representative of the medical material identifying number, the extracting section 32 extracts the server data relative to the medical material identifying number, from the database 12. The Web page providing section 34 produces the Web page information which includes the extracted server data.

At a twelfth step S12, the extracted data transmitting section 33 transmits the extracted data to the mobile terminal device 6. When the mobile terminal device 6 receives the data from the server 7 by the server data receiving section 24 at a thirteenth step S13, the server data displaying section 25 displays the received data at a fourteenth step S14.

Incidentally, the Web page is displayed by a browser function which the server data displaying section 25 has, in case where the data are received in form of Web page information by the mobile terminal device 6. In case where a link function is embedded in the Web page, it is possible to receive other relative Web page information and to display the other relative Web page information by operating the link function.

As described above, it is possible to provide the medical material distributing system that uses the IC tag and that is capable of obtaining further detailed information in comparison to the information which is memorized in the IC tag, with respect to the medical material such as medicine, according to the medical material distributing and consulting system of the present invention.

In addition, it is possible to easily obtain necessary data when requesting the Web page which includes the request data, in accordance with the URL, in case where the information memorized in the IC tag includes the URL.

Furthermore, it is possible to certainly obtain the necessary data when requesting the server data in accordance with the medical material identifying number, in case where the information memorized in the IC tag is representative of the medical material identifying number.

Inasmuch as the server 7 comprises the Web page providing section 34 for providing the data of database 12 in form of the Web page and the extracted data transmitting section 33 transmits the mobile terminal device 6 with the Web page provided by the Web page providing section 34, it is possible to provide the data in a simple system using the Internet and to display the data in an easily visible state by the Web page.

Inasmuch as the mobile terminal device 6 comprises the IC tag data displaying section 26 for displaying the received IC tag data, it is possible to see the IC tag data on the mobile terminal device 6.

In addition, it is possible to simplify the outside appearance in the combined structure of the IC tag reader-writer 5 and the mobile terminal device 6 in case where the IC tag reader-writer 5 is added to the mobile terminal device 6 internally, inasmuch as the IC tag reader-writer 5 is added to the mobile terminal device 6 internally or externally. In case where the IC tag reader-writer 5 is added to the mobile terminal device 6 externally, it is possible to detach the IC tag reader-writer 5 from the mobile terminal device 6 when the IC tag reader-writer 5 is not used.

Incidentally, the extracted server data may be transmitted in form of an e-mail to the mobile terminal device 6 without embedding the extracted server data in the Web page information.

In addition, the server 7 may first supply the mobile terminal device 6 with inputting Web page information relative to the URL, in case where the data request signal is representative of the URL. In this case, the medical material identifying number is inputted on the inputting Web page in the mobile terminal device 6. When the medical material identifying number, which is inputted on the inputting Web page, is received in the server 7, the server 7 produces the Web page information which includes the server data relative to the medical material identifying number, by the Web page providing section 34.

Furthermore, the inputting Web page may be requested at first, in case where the data request signal is representative of the medical material identifying number. In this case, the medical material identifying number of the IC tag 4 is inputted on the inputting Web page, in order to transmit the medical material identifying number to the server 7.

In a manner similar to the mobile terminal device 6, the computer 11 is capable of receiving the IC tag data from the IC tag 4 which is installed in the medical material 2, through the IC tag reader-writer 10. Although the computer 11 is capable of receiving the data from the server 7 in accordance with the IC tag data, description will be omitted inasmuch as the operation is similar to that of the mobile terminal device 6.

Although the IC tag 4 is installed in the medical material 2 in the medical material distributing system in the medical material distributing and consulting system 1, it is not defined to install the IC tag 4 in the medical material 2. Instead of the medical material 2, the IC tag 4 may be installed in other article or material. Even if the IC tag 4 is installed in the other article or material, it is possible to obtain the effect similar to the medical material 2.

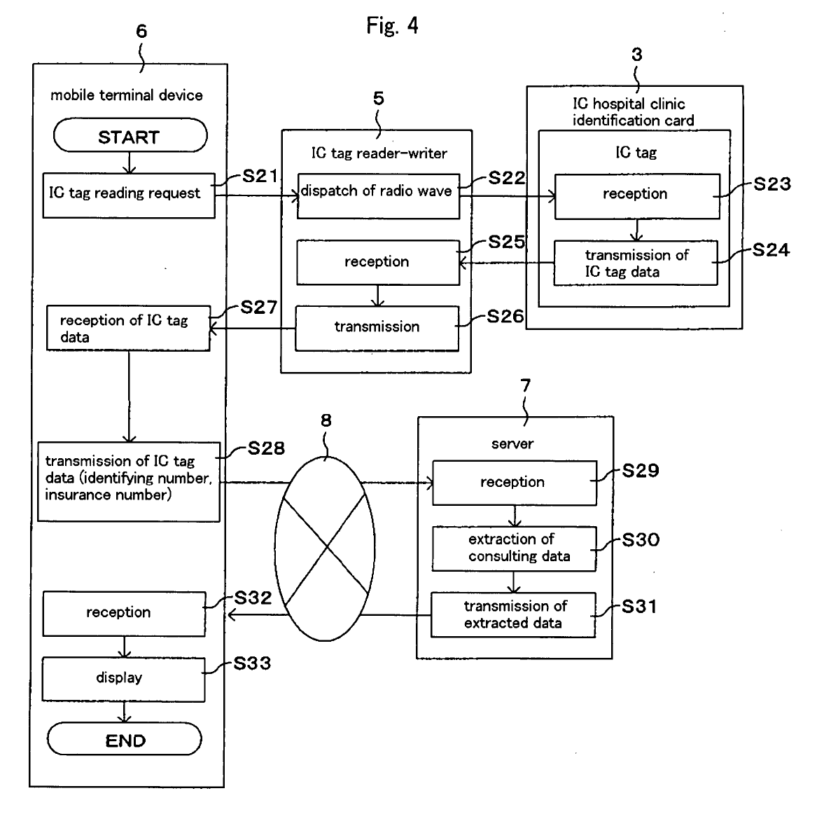

Next, description will proceed to a processing flow of the consulting system in the medical material distributing system and consulting system 1 with reference to FIG. 4 together with FIG. 1 and FIGS. 2A to 2C, on using the mobile terminal device 6.

At a first step S21, an operator operates the mobile terminal device 6, in order to transmit the reading request signal for the IC tag 4 to the IC tag reader-writer 5 by the IC tag reading request section 21.

At a second step S22, the IC tag reader-writer 5 receives the reading request signal and dispatches a radio wave to the IC tag 4 which is installed in the IC hospital clinic identification card 3. When the IC tag 4 receives the radio wave from the IC tag reader-writer 5 at a third step S23, the IC tag 4 dispatches the IC tag data to the IC tag reader-writer 5 at a fourth step S24. The IC tag data is representative of the identifying number of IC tag 4 and an insurance number of the hospital clinic identification card holder or the URL of Web page information which includes consulting information of the hospital clinic identification card holder.

When the IC tag reader-writer 5 receives the IC tag data from the IC tag 4 at the fifth step S25, the IC tag reader-writer 5 transmits the IC tag data to the mobile terminal device 6 at a sixth step S26.

When the mobile terminal device 6 receives the IC tag data from the IC tag reader-writer 5 by the IC tag data receiving section 22 at a seventh step S27, the mobile terminal device 6 transmits the data request signal to the server 7 by the server data request transmitting section 23 through the communication line network 8 at an eighth step S28, in order to request the server data relative to the IC tag data.

The data request signal is representative of the identifying number of IC tag 4 and an insurance number of the hospital clinic identification card holder or the URL of Web page information which includes consulting information of the hospital clinic identification card holder.

When the server 7 receives the data request signal by the data request receiving section 31 at a ninth step S29, the server 7 extracts the server data from the database 12 which is installed in the server 7, by the extracting section 32 in accordance with the data request signal at a tenth step S30.

At that time, the extracting section 32 extracts the Web page information which is produced in advance by the Web page providing section 34 and which corresponds to the URL, from the database 12, in case where the data request signal is representative of the URL.

In case where the data request signal is representative of the IC hospital clinic identification card identifying number and the insurance number, the extracting section 32 extracts the server data relative to these numbers. The Web page providing section 34 embeds the server data in the Web page information.

The extracted data transmitting section 33 transmits the extracted data to the mobile terminal device 6 at an eleventh step S31.

When the mobile terminal device 6 receives the data from the server 7 by the server data receiving section 24 at a twelfth step S32, the server data displaying section 25 displays the received data at a thirteenth step S33.

Incidentally, the Web page is displayed by a browser function of the mobile terminal device 6, in case where the data is received in form of Web page information by the mobile terminal device 6. In case where a link function is embedded in the Web page, it is possible to receive other relative Web page information and to display the other relative Web page information by operating the link function.

As described above, it is possible to obtain further detailed information of a patient in comparison to the information which is memorized in the IC tag or the information memorized in the hospital clinic identification card, according to the consulting system in the medical material distributing and consulting system 1 of the present invention.

Incidentally, the server 7 may first supply the mobile terminal device 6 with inputting Web page information relative to the URL, in case where the data request signal is representative of the URL. In this case, the identifying number and the insurance number are inputted on the inputting Web page in the mobile terminal device 6. When the identifying number and the insurance number, which are inputted on the inputting Web page, are received in the server 7, the server 7 produces the Web page information which includes the server data relative to the identifying number and the insurance number, by the Web page providing section 34.

In addition, the inputting Web page may be requested at first, in case where the data request signal is representative of the identifying number of the IC tag 4 and the insurance number of the hospital clinic identification card holder. In this case, the identifying number of the IC tag 4 and the insurance number of the hospital clinic identification card holder are inputted on the inputting Web page, in order to supply the server 7 with the identifying number of the IC tag 4 and the insurance number of the hospital clinic identification card holder.

In a manner similar to the mobile terminal device 6, the computer 11 is capable of receiving the IC tag data from the IC tag 4 which is installed in the IC hospital clinic identification card 3, through the IC tag reader-writer 10. Although the computer 11 is capable of receiving the data from the server 7 in accordance with the IC tag data, description will be omitted inasmuch as the operation is similar to that of the mobile terminal device 6.

Although the IC tag reader-writer 5, which is added to the mobile terminal device 6 internally or externally, carries out reading and writing operations with respect to the IC tag 4 which is installed in the medical material 2 or the IC hospital clinic identification card 3, in the medical material distributing and consulting system 1, it is applicable to other systems without defining the medical material distributing and consulting system 1. In addition, it is not defined to install the IC tag 4 in the medical material 2 or the IC hospital clinic identification card 3. It is possible to carry out reading and writing operation with respect to a general IC tag which is installed in each of other materials, because of widely using the IC tag 4.

1. A medical material distributing and consulting system comprising a server and a mobile terminal device communicable with said server through a communication line network using Internet, said mobile terminal device having an IC tag reader-writer for carrying out reading operation and/or writing operation with respect to an IC tag which is installed in a medical material or an IC hospital clinic identification card, wherein:
said mobile terminal device comprises:
IC tag reading request means for transmitting a reading request signal for the IC tag to said IC tag reader-writer;
IC tag data receiving means for receiving IC tag data from said IC tag reader-writer which reads said IC tag data from said IC tag;
server data request transmitting means for a data request signal to said server, in order to request server data relative to said IC tag data;
server data receiving means for receiving data from said server; and
server data displaying means for displaying the data received from said server;
said server comprising:
data request receiving means for receiving said data request signal from said mobile terminal device;
extracting means for extracting data from a database installed in said server, in accordance with said data request signal; and
extracted data transmitting means for transmitting the extracted data to said mobile terminal device.

2. A medical material distributing and consulting system as claimed in claim 1, wherein:
a computer is communicable with said server through said communication line network using Internet, said computer having an IC tag reader-writer for carrying out reading operation and/or writing operation with respect to said IC tag which is installed in said medical material or said IC hospital clinic identification card;
said computer comprising:
IC tag reading request means for transmitting a reading request signal for the IC tag to said IC tag reader-writer;
IC tag data receiving means for receiving IC tag data from said IC tag reader-writer which reads said IC tag data from said IC tag;
server data request transmitting means for a data request signal to said server, in order to request server data relative to said IC tag data;
server data receiving means for receiving data from said server; and
server data displaying means for displaying the data received from said server.

3. A medical material distributing and consulting system as claimed in claim 1, wherein said data request signal transmitted by said server data request transmitting means is representative of a URL.

4. A medical material distributing and consulting system as claimed in claim 1, wherein said data request signal transmitted by said server data request transmitting means is representative of a medical material identifying number for use in identifying said medical material, or an IC hospital clinic identification card identifying number for use in identifying an IC hospital clinic identification card, and an insurance number for patient having said IC hospital clinic identification card.

5. A medical material distributing and consulting system as claimed in claim 1, wherein:
said server comprises Web page providing means for providing the data of said database as a Web page; and
said extracted data transmitting means transmitting said Web page provided by said Web page providing means, to said mobile terminal device as said extracted data.

6. A medical material distributing and consulting system as claimed in claim 1, wherein said mobile terminal device or said computer comprises IC tag data displaying means for displaying said IC tag data received from said IC tag.

7. A medical material distributing and consulting system as claimed in claim 1, wherein said IC tag reader-writer installed in said mobile terminal device is added to said mobile terminal device internally or externally.
